(19) United States
(12) Patent Application Publication
(10) Pub. No.: US 2026/0349434 A1
(43) Pub. Date: Nov. 5, 2026

(54) FOOT-LOCAL PREDICTIVE CONTACT VALIDATION FOR HUMANOID ROBOT LOCOMOTION

(71) Applicant: Dorian Cartwright, San Jose, CA (US)

(72) Inventor: Dorian Cartwright, San Jose, CA (US)

(21) Appl. No.: 19/738,370

(22) Filed: Jul. 11, 2026

Related U.S. Application Data
(63) Continuation-in-part of application No. 19/638,074, filed on Apr. 2, 2026.

(51) Int. Cl. G05D 1/617; B62D 57/032; G05B 13/04; G05D 1/495; G05D 109/12

(52) U.S. Cl. CPC G05D 1/617; B62D 57/032; G05B 13/048; G05D 1/495; G05D 2109/12

(57) ABSTRACT

A humanoid robot system includes a locomotion controller, robotic foot assembly, foot-local predictive contact validator, and footfall-release controller. A candidate footfall command is received for the robotic foot assembly. Before weight transfer or lower-body actuator execution, the foot-local predictive contact validator evaluates local foot state, terrain state, and body-state context to predict a contact consequence associated with the candidate footfall command. The predicted contact consequence may include slip risk, toe overhang, terrain-compliance mismatch, insufficient contact area, ankle torque overload, or unsafe load transfer. The footfall-release controller evaluates the predicted contact consequence against a footfall-safety policy and selectively releases, modifies, delays, or blocks the candidate footfall command. In some embodiments, a release authorization defines a validator-derived support envelope enforced by one or more downstream actuator controllers.

### CROSS-REFERENCE TO RELATED APPLICATION(S)

This application is a continuation-in-part of U.S. patent application Ser. No. 19/638,074, filed Apr. 2, 2026, by Dorian Cartwright and entitled PREDICTIVE ACTUATION GATING IN PHYSICAL ARTIFICIAL INTELLIGENCE, the entire contents of which are incorporated herein by reference.

This application is related to U.S. patent application Ser. No. 19/686,121, filed May 22, 2026, by Dorian Cartwright and entitled HAND-LOCAL PREDICTIVE TACTILE ACTUATION GATE FOR DEXTEROUS ROBOTIC MANIPULATION, the entire contents of which are incorporated herein by reference.

This application is also related to U.S. Provisional Patent Application No. 64/070,361, filed May 20, 2026, by Dorian Cartwright and entitled HARDWARE-ENFORCED VALIDATED ACTUATION FOR AUTONOMOUS PHYSICAL ARTIFICIAL INTELLIGENCE SYSTEMS, and U.S. Provisional Patent Application No. 64/070,365, filed May 20, 2026, by Dorian Cartwright and entitled PROTECTED PHYSICAL ARTIFICIAL INTELLIGENCE ACTUATOR FIREWALL OPERATING SYSTEM, the entire contents of each being incorporated herein by reference.

This application is also related to U.S. Provisional Patent Application No. 64/100,701, filed Jun. 28, 2026, by Dorian Cartwright and entitled MANDATORY ACTUATION-DISPATCH TRUST ARCHITECTURE FOR PHYSICAL ARTIFICIAL INTELLIGENCE (AI) SYSTEMS, the entire contents of which are incorporated herein by reference.

### FIELD OF THE INVENTION

The present disclosure relates generally to computers and artificial intelligence, and more specifically, to foot-local predictive contact validation for humanoid robot locomotion before weight transfer, foot actuator execution, ankle actuator execution, toe actuator execution, sole actuator execution, or adaptive sole actuation.

### BACKGROUND

Humanoid robots increasingly rely on vision-language-action models, learned locomotion policies, reinforcement-learning controllers, whole-body planners, teleoperation systems, robot operating systems, and actuator firewalls to generate candidate locomotion actions. Such actions may include walking, turning, stair climbing, ramp traversal, push recovery, bracing, balancing, load-carrying locomotion, and human-proximate movement.

A candidate footfall may appear acceptable at a visual, map-based, or whole-body planning level while still being unsafe at a local foot-contact level. For example, a proposed step may cause slip, toe overhang, stair-edge instability, insufficient contact patch, excessive shear force, ankle torque overload, sole deformation, contamination-related traction loss, excessive load-transfer rate, or instability during support transition.

Conventional locomotion systems often rely on whole-body planners, gait generators, model-predictive controllers, zero-moment-point controllers, terrain maps, or post-contact slip detection. These approaches may react after the foot has already contacted the ground or after the robot has already begun transferring weight. They do not adequately provide a foot-local predictive validation layer that evaluates whether a proposed footfall should be released before the robot commits body weight to the support surface.

The foot is not isolated from the rest of the humanoid body. A proposed footfall may depend on upstream same-leg state, opposing lower-limb state, torso state, center-of-mass state, payload state, and optional upper-body state. For example, hip rotation, knee extension, ankle torque, opposite-foot support, torso lean, arm configuration, shoulder load, or an object carried by a hand may alter whether a particular foot placement is safe. However, these body-state relationships are often evaluated at a general locomotion-planning level rather than at a foot-local release authority that determines whether a specific footfall may be physically executed.

There is therefore a need for a foot-local predictive contact validator that receives a candidate footfall command, evaluates local sole, toe, heel, ankle, terrain, friction, edge, support, load-transfer, and contextual body-state conditions, and selectively releases, modifies, delays, decomposes, or blocks the candidate footfall before full weight transfer or actuator execution.

### SUMMARY

A humanoid robot includes a robot brain, an action generator, a locomotion controller, one or more robotic foot assemblies, and a foot-local predictive contact validator. The action generator generates a candidate locomotion action. The locomotion controller generates a candidate footfall command for a robotic foot assembly. Before full weight transfer or corresponding foot, ankle, toe, sole, stiffness, or lower-body actuator execution is released, the foot-local predictive contact validator predicts one or more contact consequences of executing the candidate footfall command.

The predicted contact consequence may include slip risk, terrain-compliance mismatch, sole deformation, toe overhang, stair-edge instability, insufficient contact area, ankle torque overload, excessive shear force, contamination-related traction loss, balance-margin loss, support-polygon insufficiency, unstable load-transfer rate, or push-off failure.

The foot-local predictive contact validator may receive local foot state together with body-state context. The body-state context may include one or more of pelvis state, hip state, knee state, opposite-leg state, opposite-foot state, torso state, shoulder state, arm state, elbow state, wrist state, hand state, carried-payload state, center-of-mass state, momentum state, balance-margin state, or support-polygon state. The body-state context is used as contextual information for determining whether to authorize the candidate footfall, while the foot-local predictive contact validator remains directed to validating release of the candidate footfall.

A footfall-release controller evaluates the predicted contact consequence against a footfall-safety policy and selectively releases, modifies, delays, decomposes, or blocks the candidate footfall command. In some embodiments, the release is embodied as a time-bounded or actuator-specific release authorization defining a validator-derived support envelope for one or more foot, ankle, toe, sole, stiffness, brake, clutch, or motor actuators.

In some embodiments, the system performs pre-weight-transfer microcontact validation. A robotic foot assembly establishes low-force or partial contact with a support surface before full body weight is committed. The validator uses resulting contact data to estimate friction, compliance, edge location, contamination, roughness, deformation, support area, or load-transfer feasibility.

In some embodiments, an adaptive sole includes variable-compliance zones. The adaptive sole may modify stiffness, damping, tread engagement, contact area, toe compliance, heel compliance, arch support, or frictional engagement according to a validated terrain envelope before contact or before full load transfer.

In some embodiments, the system validates stair-edge or terrain-edge footfalls. The system determines a toe-overhang metric, available contact area, minimum safe contact area, support-polygon sufficiency, and predicted load-transfer consequence, and modifies or blocks a candidate footfall when the predicted contact is unsafe.

Many variations are possible.

### BRIEF DESCRIPTION OF THE DRAWINGS

The present disclosure will be understood more fully from the detailed description given below and from the accompanying drawings of various embodiments of the disclosure.

FIG. 1 is a block diagram illustrating a humanoid robot having lower-body/locomotion predictive validation, according to an embodiment.

FIG. 2 is a sequence diagram illustrating humanoid lower-body/locomotion predictive validation system of FIG. 1, according to an embodiment.

FIG. 3A is a more-detailed block diagram illustrating components of a foot-local predictive validator, according to an embodiment.

FIG. 3B is a more-detailed block diagram illustrating components of a robotic foot assembly, according to an embodiment.

FIG. 4 is a block diagram illustrating a robotics computing environment for implementing the disclosed systems and methods, according to an embodiment.

FIG. 5 is a flow chart illustrating an overall method for foot-local predictive contact validation before weight transfer, according to an embodiment.

FIG. 6 is a flow chart illustrating a method for pre-weight-transfer microcontact validation, according to an embodiment.

FIG. 7 is a flow chart illustrating a method for stair-edge or terrain-edge footfall validation, according to an embodiment.

FIG. 8 is a flow chart illustrating a method for generating and enforcing a footfall release authorization, according to an embodiment.

### DETAILED DESCRIPTION

The following description sets forth systems, methods, and computer program products for foot-local predictive contact validation for humanoid robot locomotion. Although numerous implementation details are provided for explanatory purposes, the disclosed subject matter is not limited to the illustrated embodiments. Features described with respect to one embodiment may be combined with features of other embodiments unless otherwise indicated.

The disclosed validator operates as a localized validation layer positioned between a locomotion controller and one or more lower-body actuators. Rather than permitting candidate locomotion actions to directly control lower-body actuators, the validator predicts local foot-contact consequences before authorizing physical execution.

In some embodiments, the foot-local predictive contact validator operates as a body-region-specific validator within a broader runtime actuation-dispatch trust architecture. The foot-local predictive contact validator may receive candidate footfall commands from a locomotion controller while operating under a higher-level runtime enforcement engine, actuator firewall, or dispatch authorization system. The validator may therefore function as one stage of a hierarchical validation architecture in which whole-body validation, subsystem validation, and actuator-level validation cooperate to authorize physical execution.

### I. Systems

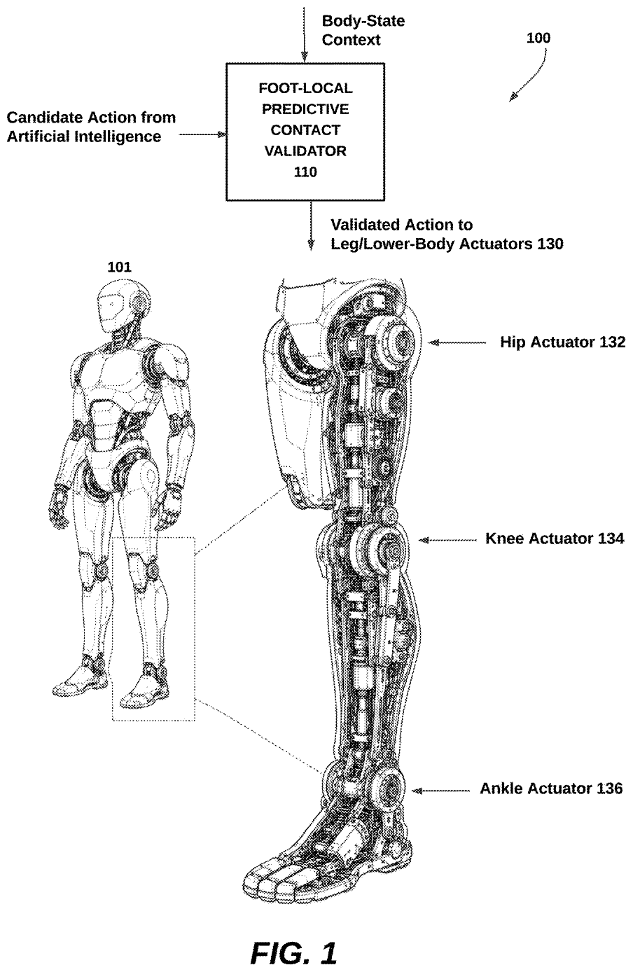

### A. Humanoid Robot Including Foot-Local Predictive Contact Validator (FIG. 1)

FIG. 1 illustrates a humanoid robot system 100 including a humanoid robot 101. The humanoid robot 101 includes a robot brain located within an upper portion of the humanoid robot and configured to execute an action generator 120. The humanoid robot further includes one or more lower-body actuators 130 configured to physically control hip joints with hip actuators 132, knee joints with knee actuators 134, ankle joints with ankle actuators 136, feet, toes, or other lower-body mechanisms involved in locomotion and balance. A foot-local predictive contact validator 110 is logically positioned between the action generator 120 and the lower-body actuators 130 to evaluate candidate locomotion actions before physical execution.

The action generator 120 generates one or more candidate locomotion actions responsive to one or more inputs. The inputs may include user commands, spoken instructions, natural-language prompts, mission objectives, navigation goals, teleoperation commands, environmental observations, visual images, depth images, lidar data, inertial measurements, localization data, maps, digital twins, world models, reinforcement-learning policies, behavior trees, symbolic planners, or other information. In various embodiments, the action generator 120 may comprise a vision-language-action (VLA) model, vision-language model, robot foundation model, multimodal transformer, reinforcement-learning policy, diffusion policy, motion planner, whole-body planner, teleoperation interpreter, behavior-tree engine, symbolic reasoning engine, deterministic controller, or combinations thereof.

The candidate locomotion actions generated by the action generator 120 may correspond to substantially any lower-body movement or locomotion objective. Example candidate locomotion actions include walking forward, walking backward, side stepping, diagonal stepping, turning, pivoting, balancing, standing from a seated position, kneeling, crouching, stair ascent, stair descent, ramp traversal, obstacle avoidance, stepping over an obstacle, crossing a threshold, stepping onto a curb, stepping onto uneven terrain, entering an elevator, push recovery, cooperative carrying, load-bearing locomotion, dynamic balance recovery, dancing, athletic movement, industrial movement, warehouse movement, medical assistance, home assistance, or combinations thereof.

The action generator 120 generally produces a candidate locomotion action representing an intended physical behavior rather than direct electrical motor commands. In one example, a vision-language-action model may receive the instruction “walk to the kitchen and retrieve a bottle.” The action generator 120 may generate a candidate locomotion action comprising a sequence of candidate footfall commands representing individual left-foot and right-foot placements required to traverse the environment. In another example, the action generator 120 receives environmental observations indicating a staircase and generates candidate stair climbing footfall commands. In another example, a teleoperation operator commands the robot to step onto a loading dock, resulting in one or more candidate edge-contact footfall commands.

The candidate locomotion action propagates from the action generator 120 to the locomotion controller 140, which converts the candidate locomotion action into one or more candidate footfall commands. Before a candidate footfall command is physically executed by the lower-body actuators 130, the foot-local predictive contact validator 110 predicts one or more contact consequences associated with the proposed footfall. The predicted contact consequence is supplied to the footfall-release controller 150, which may release, modify, delay, decompose, or block the candidate footfall command.

An authorized command may thereafter be transmitted to one or more actuator controllers associated with the lower-body actuators 130. The lower-body actuators 130 include one or more electromechanical actuator systems configured to physically move the lower body of the humanoid robot. The lower-body actuators may include hip actuators, knee actuators, ankle actuators, toe actuators, heel actuators, sole-stiffness actuators, foot-orientation actuators, brake actuators, clutch actuators, or combinations thereof. The actuators may comprise electric motors, servo motors, brushless DC motors, linear actuators, harmonic-drive actuators, planetary gear actuators, cable-driven actuators, tendon-driven actuators, hydraulic actuators, pneumatic actuators, or other actuation systems. Mechanical transmission components may include belts, pulleys, gears, cable systems, tendons, harmonic drives, ball screws, linkages, reduction gearboxes, bearings, springs, dampers, compliant mechanisms, or other force-transmission components. Electrical power and control signals may be provided through wiring harnesses, printed circuit assemblies, flexible cables, distributed actuator controllers, embedded motor controllers, or other electrical interconnections.

The lower-body actuators 130 execute a candidate footfall command only pursuant to a valid release authorization generated by the footfall-release controller 150 based at least in part on an output of the foot-local predictive contact validator 110. In some embodiments, the release authorization comprises a validator-derived support envelope. The support envelope may define one or more permissible operating ranges including permitted foot placement, permitted contact area, permitted ankle orientation, permitted toe angle, permitted ground-reaction force, permitted load-transfer rate, permitted sole stiffness, permitted push-off force, permitted gait phase, permitted actuator torque, permitted motor current, permitted actuator velocity, permitted actuator acceleration, or permitted execution time. A downstream actuator controller may reject, clip, pause, revoke, or terminate execution if the release authorization is absent, invalid, expired, or exceeded.

For example, a candidate locomotion action may specify stepping onto the edge of a stair tread. The foot-local predictive contact validator 110 predicts that the proposed foot placement will result in excessive toe overhang and insufficient support area. Rather than authorizing unrestricted execution, the validator may deny the candidate footfall, modify the foot placement, reduce allowable load transfer, require a preliminary microcontact validation step, or authorize only a partial support envelope until additional contact information is obtained. In another example, the validator predicts adequate support but reduced friction because of a wet floor. The generated support envelope may therefore reduce allowable push-off force, limit ankle torque, decrease step velocity, and require a lower center-of-mass trajectory before permitting full weight transfer.

Advantageously, the architecture of FIG. 1 separates high-level locomotion generation from low-level physical execution. The action generator 120 remains responsible for determining what locomotion should be performed, while the foot-local predictive contact validator 110 determines whether and under what conditions the proposed locomotion may be physically executed by the lower-body actuators 130.

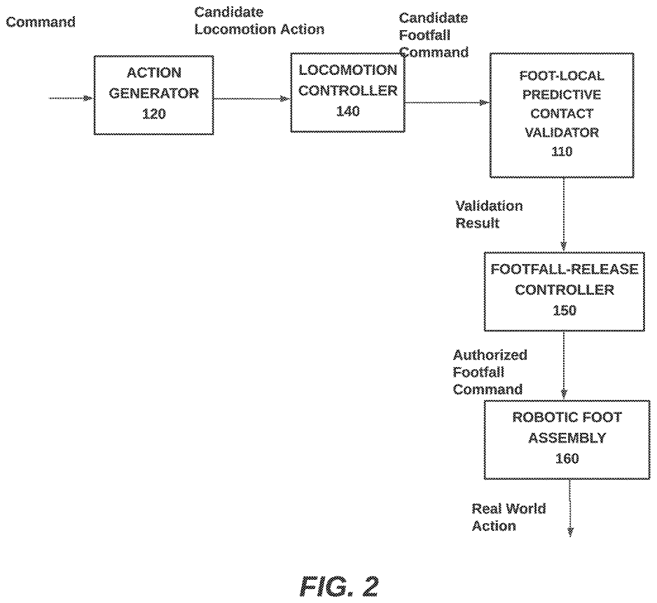

### B. Locomotion Validation Architecture (FIG. 2)

FIG. 2 illustrates a locomotion validation architecture 200 for controlling lower-body locomotion of a humanoid robot according to an embodiment. The locomotion validation architecture 200 includes an action generator 120, a locomotion controller 140, a foot-local predictive contact validator 110, a footfall release controller 150, and a robotic foot assembly 160.

When multiple validators participate in authorizing a candidate locomotion action, authorization may require unanimous approval, threshold approval, weighted approval, priority ordering, policy precedence, hierarchical evaluation, or another multi-validator arbitration technique. In some embodiments, denial by any validator prevents physical execution.

The action generator 120 generates one or more candidate locomotion actions responsive to user commands, mission objectives, navigation goals, teleoperation commands, sensor observations, environmental models, or other inputs. In various embodiments, the action generator may comprise a vision-language-action (VLA) model, robot foundation model, reinforcement-learning policy, diffusion policy, symbolic planner, behavior tree, motion planner, or other physical artificial intelligence process.

The locomotion controller 140 converts each candidate locomotion action into one or more candidate footfall commands suitable for execution by the robotic foot assembly 160. The locomotion controller may perform gait planning, inverse kinematics, trajectory generation, balance planning, timing generation, contact scheduling, load-transfer planning, or combinations thereof. Candidate footfall commands may define target foot placement, foot orientation, ankle orientation, toe orientation, heel orientation, expected contact region, ground-reaction-force estimates, gait phase, load-transfer profile, push-off profile, actuator trajectories, or other locomotion parameters.

Rather than transmitting the candidate footfall commands directly to the robotic foot assembly 160, each candidate footfall command is first transmitted to the foot-local predictive contact validator 110.

The foot-local predictive contact validator 110 evaluates the candidate footfall command using local foot state, terrain state, body-state context, and other available information to predict one or more contact consequences associated with execution of the proposed footfall. The validator may predict slip risk, contact-area sufficiency, toe overhang, terrain-compliance mismatch, ankle torque overload, excessive shear force, load-transfer instability, balance degradation, or other contact-related consequences before physical execution.

The predicted contact consequence is provided to the footfall release controller 150. The footfall release controller evaluates the predicted consequence against one or more footfall-safety policies and selectively releases, modifies, delays, decomposes, or blocks the candidate footfall command. When authorization is granted, the footfall release controller may generate a validator-derived support envelope defining one or more permitted actuator operating ranges, including allowable foot placement, contact area, ground-reaction force, ankle orientation, toe angle, load-transfer rate, actuator torque, execution timing, or other execution constraints.

The authorized footfall command is then transmitted to the robotic foot assembly 160 for physical execution.

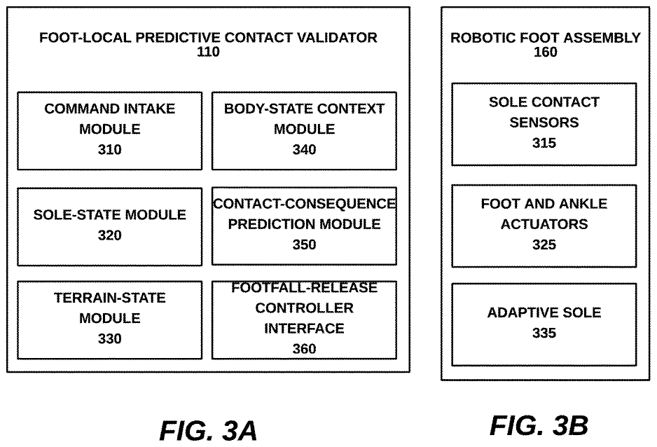

### C. Foot-Local Predictive Contact Validator (FIG. 3A)

FIG. 3A illustrates the foot-local predictive contact validator 110 in greater detail. In the illustrated embodiment, the validator includes a command intake module 310, a sole-state module 320, a terrain-state module 330, a body-state context module 340, a contact-consequence prediction module 350, and a footfall-release controller interface 360.

The command intake module 310 receives candidate footfall commands from the locomotion controller 140. Candidate footfall commands may specify proposed foot placement, approach trajectory, contact trajectory, gait phase, load-transfer profile, actuator trajectories, or other locomotion parameters associated with a proposed footfall.

The sole-state module 320 receives local foot information including pressure distribution, contact area, center of pressure, shear forces, inertial measurements, sole deformation, toe position, heel position, friction measurements, moisture measurements, temperature measurements, or other locally sensed information associated with the robotic foot assembly.

In some embodiments, the sole-state module 320 determines or maintains sole-wear data, tread-wear data, calibration state, sensor-health state, friction history, and gait-phase data. Sole-wear data may be generated from accumulated contact cycles, changes in tread geometry, changes in measured friction, changes in sole compliance, pressure-distribution changes, inspection data, or combinations thereof. The validator may increase a safety margin, reduce permitted push-off force, require microcontact validation, or request maintenance when sole wear exceeds a threshold.

The terrain-state module 330 determines characteristics of the support surface including terrain geometry, compliance, friction, slope, stair edges, curb edges, gaps, obstacles, contamination, roughness, or other terrain properties obtained from local sensors, environmental maps, digital twins, historical telemetry, or perception systems.

The body-state context module 340 receives contextual information describing the remainder of the humanoid robot. Example body-state context may include pelvis orientation, hip state, knee state, opposite-leg state, torso orientation, carried payload, center-of-mass location, support polygon, momentum, balance margin, upper-body posture, or other information affecting locomotion stability.

Body-state context may further include object-retention state, payload-retention confidence, payload mass, payload inertia, payload position, or a determination that a carried object has shifted relative to the humanoid robot. A change in object-retention state or payload distribution may alter center-of-mass position, angular momentum, required contact area, permitted ankle torque, permitted load-transfer rate, or another footfall-safety criterion.

The contact-consequence prediction module 350 supplies a predicted contact consequence, confidence value, validation result, or combination thereof to the footfall-release controller interface 360. The interface 360 communicates with the footfall-release controller 150 and may receive a release, modification, delay, decomposition, microcontact, or block decision together with any validator-derived support envelope. The interface 360 may return the decision to the locomotion controller 140, transmit an authorized command to an actuator controller, or both.

The predicted contact consequence is transmitted to the footfall-release controller interface 360, which communicates the prediction to the footfall release controller 150. Responsive to authorization, the validator may receive a release authorization defining a validator-derived support envelope for subsequent execution by the robotic foot assembly 160. If the proposed footfall fails one or more validation policies, the validator may instead request modification, replanning, staged execution, microcontact validation, or complete rejection of the candidate footfall command.

In some embodiments, multiple predictive validators operate simultaneously. A whole-body validator may evaluate coordinated locomotion, balance, payload, and mission objectives, while the disclosed foot-local predictive contact validator independently evaluates local contact safety associated with a candidate footfall. Authorization for physical execution may require successful evaluation by one or more validators operating at different abstraction levels.

### D. Robotic Foot Assembly (FIG. 3B)

FIG. 3B illustrates the robotic foot assembly 160. The robotic foot assembly 160 includes one or more sole contact sensors 315, one or more foot and ankle actuators 325, and an adaptive sole 335. The robotic foot assembly 160 receives an authorized footfall command, or one or more actuator commands derived from the authorized footfall command, after validation by the foot-local predictive contact validator 110 and authorization by the footfall release controller 150.

The robotic foot assembly 160 may be mechanically connected to a lower leg of the humanoid robot through an ankle joint. In another embodiment, the lower leg can be a prosthetic that is independent of a humanoid. In still another embodiment, the lower leg can be a modular replacement that is vendor-agnostic. The robotic foot assembly 160 may include a heel region, midfoot region, forefoot region, toe region, medial region, lateral region, structural frame, compliant layer, exterior tread, actuator mounting structure, sensor layer, wiring, embedded controller, or combinations thereof.

The sole contact sensors 315 detect local conditions at or near an interface between the robotic foot assembly 160 and a support surface. The sole contact sensors 315 may be distributed across the heel, midfoot, forefoot, toe, medial sole, lateral sole, sole perimeter, or another region of the robotic foot assembly 160. In some embodiments, multiple sensors form a sensor array that produces a spatial map of pressure, force, shear, deformation, temperature, moisture, or contact.

Pressure sensors may measure normal pressure applied to individual sole regions. Pressure measurements from a plurality of sensors may be used to determine whether contact exists, estimate a total normal force, estimate a pressure distribution, identify a center of pressure, determine an effective contact patch, or detect pressure concentration near a sole edge.

Shear sensors may measure tangential force acting parallel to the support surface. Shear data may be compared with normal-force data to estimate a friction demand or detect impending slip. For example, increasing lateral shear combined with substantially unchanged normal force may indicate that the robotic foot is approaching an available friction limit.

Tactile sensors may detect contact location, contact texture, surface roughness, micro-vibration, incipient slip, local deformation, or changes in contact condition. Optical tactile sensors may produce images of deformation within a compliant sensing surface. Capacitive, resistive, piezoelectric, magnetic, or fluid-based tactile sensors may produce signals corresponding to local force or deformation.

Force and torque sensors may be positioned within the foot, ankle, or connection between the foot and lower leg. Such sensors may measure one or more components of ground-reaction force, ankle torque, bending moment, torsional load, or load-transfer rate. The measured force and torque may be compared with values authorized by a support envelope or predicted by the foot-local predictive contact validator 110.

Inertial sensors may include one or more accelerometers or gyroscopes positioned within the robotic foot assembly 160. The inertial sensors may detect foot acceleration, angular velocity, impact, vibration, unexpected rotation, loss of support, or movement relative to an expected foot pose. An unexpected lateral acceleration after contact may indicate slip, while unexpected angular rotation may indicate edge instability or insufficient contact area.

Moisture sensors may detect water, oil, cleaning fluid, condensation, or another liquid at the support surface. Temperature sensors may detect a hot, cold, frozen, or otherwise temperature-sensitive surface. Contamination sensors may detect dust, grease, debris, loose particulate matter, or another condition affecting traction or sole operation.

Edge sensors or proximity sensors may detect a stair edge, curb edge, ledge edge, threshold edge, pallet edge, loading-dock edge, ramp break, grade transition, gap, hole, or end of a support surface. The edge sensors may be located around a perimeter of the sole and may use optical, ultrasonic, capacitive, infrared, mechanical, or other sensing techniques. Edge data may be used to estimate toe overhang, heel overhang, available support area, or the location of a terrain boundary relative to the robotic foot.

Compression or deformation sensors may detect deformation of the adaptive sole 335 or compression of the support surface. Such measurements may be used to estimate terrain compliance, sole compliance, contact-area growth, subsidence, or instability on a deformable surface such as carpet, soil, gravel, foam, mud, or vegetation.

The local contact conditions detected by the sole contact sensors 315 may include contact presence, contact absence, contact location, contact area, normal force, shear force, pressure distribution, center of pressure, friction condition, incipient slip, active slip, terrain compliance, surface deformation, sole deformation, surface roughness, surface temperature, surface moisture, contamination, edge position, toe overhang, heel overhang, support continuity, impact magnitude, load-transfer rate, or ground-reaction force.

The sole contact sensors 315 may provide sensor data before contact, during microcontact, during partial load transfer, during full load transfer, during push-off, or during release from the support surface. The sensor data may be transmitted to the foot-local predictive contact validator 110, footfall release controller 150, locomotion controller 140, or a local foot controller. The data may be used to confirm a predicted contact consequence, update a support envelope, authorize a later stage, modify actuator operation, or revoke an existing authorization.

The foot and ankle actuators 325 physically implement an authorized footfall command. The foot and ankle actuators 325 may include one or more electric motors, servo motors, brushless DC motors, linear actuators, rotary actuators, hydraulic actuators, pneumatic actuators, cable-driven actuators, tendon-driven actuators, brakes, clutches, springs, dampers, or variable-stiffness mechanisms.

The foot and ankle actuators 325 may control dorsiflexion, plantar flexion, inversion, eversion, toe flexion, toe extension, heel motion, forefoot motion, sole articulation, foot rotation, stiffness, damping, or tread engagement. A motor may transfer rotational force through one or more gears, harmonic drives, belts, pulleys, cables, tendons, ball screws, linkages, or other transmission components. Electrical wiring or flexible conductors may carry electrical power, command signals, sensor signals, or network communications between an actuator controller and the motors or sensors.

The footfall release controller 150 may transmit an authorized footfall command or release authorization to an actuator controller associated with the foot and ankle actuators 325. The actuator controller may verify the authorization and convert authorized trajectory, force, torque, position, velocity, stiffness, or timing parameters into motor-control signals. Example motor-control signals include commanded current, voltage, torque, position, velocity, pulse-width modulation, valve position, brake state, or clutch state.

The foot and ankle actuators 325 may execute only a portion of a footfall command corresponding to a currently authorized stage. For example, the actuators may initially execute an approach command that positions the robotic foot near a support surface. After authorization of microcontact, the actuators may lower the foot until a predetermined contact force is detected. The actuators may then hold the foot position while the sole contact sensors 315 collect contact data. Full load transfer may remain inhibited until a subsequent authorization is received.

A validator-derived support envelope may limit operation of the foot and ankle actuators 325. The support envelope may specify permitted foot pose, ankle angle, toe angle, actuator torque, motor current, contact force, ground-reaction force, load-transfer rate, sole stiffness, push-off force, execution duration, or other operating bounds. The actuator controller may clip a command to remain within the envelope, reject an out-of-envelope command, pause execution, or terminate execution when an authorized bound is exceeded.

For example, a candidate stair footfall may be authorized subject to an ankle-torque limit, a minimum detected contact area, and a maximum load-transfer rate. The foot and ankle actuators 325 may position the foot on the stair and establish microcontact. If the sole contact sensors 315 detect sufficient contact area and acceptable edge position, the footfall release controller 150 may authorize progressive load transfer. If the detected contact area is insufficient, the actuators may hold position, withdraw the foot, or execute a modified placement command.

The adaptive sole 335 forms at least a portion of the support-contact surface of the robotic foot assembly 160. The adaptive sole 335 may include one or more independently controllable zones corresponding to the heel, midfoot, forefoot, toe, medial region, lateral region, or another sole region.

The adaptive sole 335 may modify stiffness, damping, compliance, tread engagement, contact area, toe support, heel support, arch support, sole curvature, surface texture, or frictional engagement. Adjustment may be performed using movable tread elements, expandable structures, fluid chambers, pneumatic chambers, hydraulic chambers, variable-stiffness materials, shape-memory materials, magnetorheological materials, electrorheological materials, mechanical linkages, springs, brakes, clutches, or embedded actuators.

The adaptive sole 335 may receive sole-configuration commands associated with an authorized footfall command. For example, the adaptive sole 335 may increase compliance on an uneven surface to increase effective contact area, increase stiffness during push-off, engage tread on a low-friction surface, raise a toe region to reduce edge interference, or alter medial and lateral stiffness to accommodate a sloped surface.

Operation of the adaptive sole 335 may also be constrained by the validator-derived support envelope. The envelope may specify permitted stiffness ranges, damping ranges, deformation limits, tread states, or zone-specific configurations. The adaptive sole 335 may therefore adapt to local terrain conditions while remaining within limits approved by the foot-local predictive contact validator 110.

In one example, the robotic foot assembly 160 approaches a wet tile surface. The sole contact sensors 315 detect moisture and reduced friction during microcontact. The foot-local predictive contact validator 110 updates a predicted slip consequence, and the footfall release controller 150 issues a restricted authorization. In response, the foot and ankle actuators 325 reduce the load-transfer rate and push-off torque, while the adaptive sole 335 increases contact area or engages a higher-traction tread configuration.

In some embodiments, the foot-local predictive contact validator continuously updates one or more validation thresholds using historical telemetry. For example, friction thresholds, toe-overhang limits, support-polygon thresholds, load-transfer limits, sole-compliance models, terrain classifications, or contact models may be adapted according to prior successful or unsuccessful footfall executions while remaining subject to one or more minimum safety constraints.

In another example, the robotic foot assembly 160 contacts a stair tread near an edge. Perimeter and pressure sensors identify toe overhang and an insufficient forefoot contact patch. The footfall release controller 150 withholds full load-transfer authorization. The foot and ankle actuators 325 maintain partial contact or withdraw the foot, and the locomotion controller 140 generates a revised foot placement farther from the stair edge.

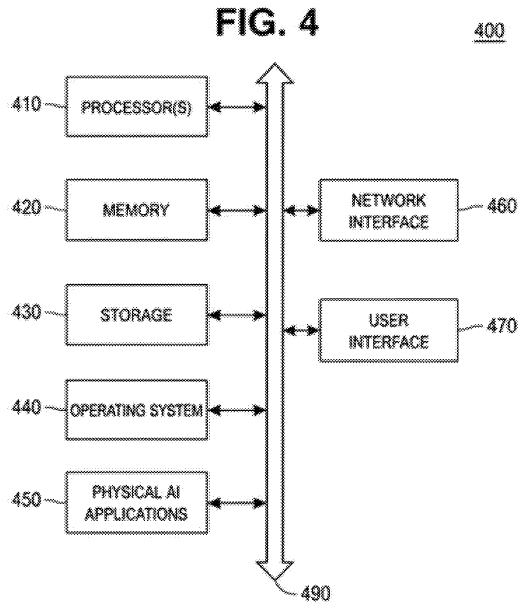

### E. Robotic Computing Environment (FIG. 4)

FIG. 4 illustrates a robotic computing environment 400, according to an embodiment.

The robotic computing environment 400 includes one or more processors 410, memory 420, storage 430, an operating system 440, one or more physical artificial intelligence applications 450, a network interface 460, a user interface 470, and a bus 490. The components may be located within the humanoid robot, distributed among multiple on-board computing devices, or divided between on-board and remote computing systems.

The one or more processors 410 may include central processing units, graphics processing units, neural processing units, digital signal processors, microcontrollers, field-programmable gate arrays, application-specific integrated circuits, or other processing devices. Contact validation and actuator-release enforcement may be performed locally, while selected perception, model training, model updating, or non-time-critical inference may be performed by one or more remote computing systems.

The memory 420 and storage 430 may store instructions, models, policies, thresholds, terrain data, body-state data, contact telemetry, release authorizations, support-envelope data, and other information used by the action generator 120, locomotion controller 140, foot-local predictive contact validator 110, footfall-release controller 150, or related software and hardware components.

The physical artificial intelligence applications 450 may include one or more locomotion applications, navigation applications, vision-language-action applications, reinforcement-learning applications, teleoperation applications, terrain-perception applications, digital-twin applications, policy-management applications, or combinations thereof.

The operating system 440 may comprise a humanoid operating system, a physical artificial intelligence operating system, a robot operating system, a Unix-based operating system, middleware, or another execution platform. The operating system 440 may provide scheduling, communications, actuator interfaces, sensor interfaces, memory management, policy enforcement, and execution services. The network interface 460 may support communication with other robotic systems, operator systems, or remote computing resources. The user interface 470 may support configuration, monitoring, diagnostics, policy management, or teleoperation. The components of the robotic computing environment 400 may communicate through the bus 490.

### II. Methods

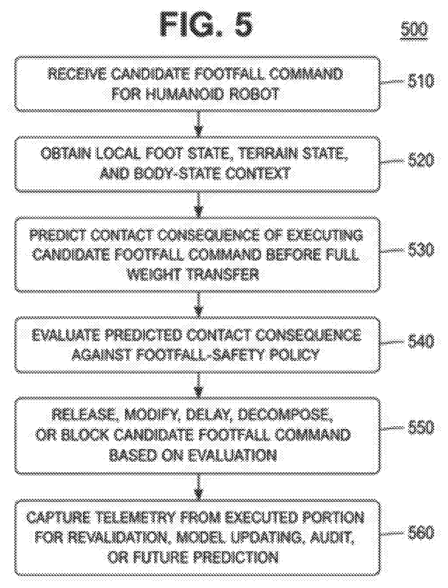

### A. Overall Foot-Local Predictive Contact Validation Method (FIG. 5)

The following methods may be implemented, for example, by the humanoid robot system 100, including the foot-local predictive contact validator 110, according to an embodiment. The steps can be performed in different orders, and functionalities can be split into more steps or combined into fewer steps, within the spirit of the present disclosure.

FIG. 5 illustrates an overall method 500 for foot-local predictive contact validation, according to an embodiment.

At step 510, a candidate footfall command is received for a humanoid robot. The candidate footfall command may be generated by the locomotion controller in response to a candidate locomotion action generated by an action generator. The candidate footfall command may specify one or more proposed foot placements, foot orientations, ankle orientations, toe orientations, heel orientations, foot trajectories, gait phases, expected contact regions, expected contact timing, expected ground-reaction forces, expected load-transfer profiles, push-off profiles, sole-stiffness settings, actuator trajectories, actuator torque limits, actuator velocity limits, actuator acceleration limits, or other parameters associated with a proposed locomotion action. In various embodiments, the candidate footfall command may be represented as a structured command object, robot operating system message, trajectory object, actuator request, data packet, shared-memory object, or another machine-readable representation.

At step 520, local foot state, terrain state, body-state context, and other contact-related information associated with the candidate footfall command are obtained. Local foot state may include one or more of sole pressure measurements, contact-patch measurements, center-of-pressure measurements, shear-force measurements, normal-force measurements, ground-reaction-force measurements, ankle angle, ankle torque, foot orientation, toe orientation, heel orientation, sole deformation, tread state, inertial measurements, moisture measurements, temperature measurements, edge measurements, actuator status, or other locally available information. Terrain state may include terrain geometry, terrain classification, stair-edge geometry, curb geometry, slope, compliance, friction estimate, roughness, contamination, obstacle geometry, surface deformation, or other environmental characteristics. Body-state context may include pelvis state, hip state, knee state, opposing-leg state, opposing-foot state, torso orientation, upper-body posture, hand state, carried-payload state, object-retention state, center-of-mass state, momentum state, balance-margin state, support-polygon state, or other kinematic or dynamic information affecting execution of the candidate footfall command. The obtained state information may originate from sole contact sensors, tactile sensors, force sensors, torque sensors, inertial sensors, visual sensors, depth sensors, proximity sensors, terrain maps, historical telemetry, prior foot contacts, digital twins, or combinations thereof.

At step 530, a predicted contact consequence associated with execution of the candidate footfall command is generated before full weight transfer. The foot-local predictive contact validator receives the candidate footfall command together with the obtained local foot state, terrain state, body-state context, and other available contact-related information and predicts one or more physical consequences expected to occur if the candidate footfall were physically executed. The prediction may be performed using one or more analytical models, rigid-body dynamics models, contact mechanics models, physics simulators, finite-element models, learned machine-learning models, neural networks, reinforcement-learning policies, probabilistic estimators, heuristic evaluators, digital twins, terrain models, empirical lookup tables, or combinations thereof.

The predicted contact consequence may include one or more of predicted slip, predicted friction margin, predicted contact area, predicted contact-force distribution, predicted center of pressure, predicted ground-reaction force, predicted load-transfer profile, predicted sole deformation, predicted terrain deformation, predicted toe overhang, predicted heel overhang, predicted stair-edge engagement, predicted curb-edge engagement, predicted ankle torque, predicted actuator loading, predicted push-off force, predicted support-polygon sufficiency, predicted balance margin, predicted gait stability, predicted contact duration, or other predicted physical consequences.

For example, predicted slip may be determined by estimating an available coefficient of friction associated with the support surface and comparing the estimated coefficient of friction with an expected tangential force, expected shear force, or expected ground-reaction force associated with the candidate footfall command. The available coefficient of friction may be estimated from terrain classification, prior foot contacts, sole-contact sensor measurements, tactile measurements, visual observations, depth observations, moisture measurements, contamination measurements, or microcontact validation data. If the expected tangential loading exceeds an allowable friction margin, the predicted contact consequence may indicate an elevated probability of slip.

Predicted contact-area sufficiency may be determined by estimating an expected contact patch between the robotic foot assembly and the support surface. The expected contact patch may be determined from the proposed foot pose together with terrain geometry, stair-edge geometry, curb geometry, obstacle geometry, sole geometry, predicted sole deformation, predicted terrain deformation, or expected load-transfer characteristics. The estimated contact patch may be compared with one or more minimum contact-area thresholds associated with a particular gait phase, payload condition, terrain classification, or support requirement. When the estimated contact area is less than a required threshold, the predicted contact consequence may indicate insufficient support.

Similarly, predicted terrain-compliance mismatch may be determined by comparing expected support behavior with predicted terrain deformation. Toe overhang may be determined by calculating an unsupported toe length extending beyond a detected terrain edge. Ankle torque overload may be predicted using expected ground-reaction forces, joint geometry, actuator capabilities, and expected body loading. Unsafe load transfer may be determined by estimating whether the proposed support transition exceeds one or more allowable force, stability, timing, balance, or actuator-capability constraints.

At step 540, the predicted contact consequence is evaluated against one or more footfall-safety policies. The footfall-safety policies define one or more acceptance criteria used to determine whether execution of the candidate footfall command should be authorized. Example footfall-safety policies include minimum contact-area policies, maximum slip-risk policies, minimum friction-margin policies, maximum ankle-torque policies, maximum sole-deformation policies, maximum toe-overhang policies, terrain-specific policies, stair-climbing policies, curb-traversal policies, ramp-traversal policies, wet-floor policies, payload-dependent policies, rehabilitation policies, human-proximity policies, balance-margin policies, support-polygon policies, actuator-capability policies, mission-specific locomotion policies, or combinations thereof.

Evaluation may comprise comparing one or more predicted contact consequences with one or more corresponding policy thresholds. In some embodiments, each predicted consequence is independently evaluated against an associated policy. In other embodiments, multiple predicted consequences are combined into a composite contact-risk score, weighted score, confidence score, probability-of-success estimate, or probabilistic safety metric that is compared with one or more acceptance thresholds. The evaluation may further consider historical telemetry, previous validation results, environmental conditions, terrain classification, gait phase, payload state, robot operating mode, mission context, operator preferences, or adaptive policies learned from previous locomotion events.

When the predicted contact consequence satisfies the applicable footfall-safety policy, the method proceeds to generate a release authorization permitting physical execution of the candidate footfall command. When one or more applicable policies are not satisfied, the candidate footfall command may be denied, modified, delayed, decomposed into smaller subcommands, rerouted to an alternate foothold, constrained by a reduced support envelope, subjected to microcontact validation, or returned to the locomotion controller for replanning.

At step 550, the candidate footfall command is released, modified, delayed, decomposed, or blocked based on the evaluation. When released, a validator-derived support envelope may be transmitted to one or more actuator controllers together with a release authorization defining permissible actuator operating ranges during execution of the candidate footfall.

At step 560, telemetry from any executed portion of the footfall is captured for revalidation, model updating, audit, policy refinement, digital-twin updating, incident reconstruction, or future footfall prediction. The telemetry may include contact forces, pressure distributions, actuator positions, actuator torques, motor currents, ground-reaction forces, sole deformation, terrain response, slip measurements, gait timing, support transitions, or other execution-related data.

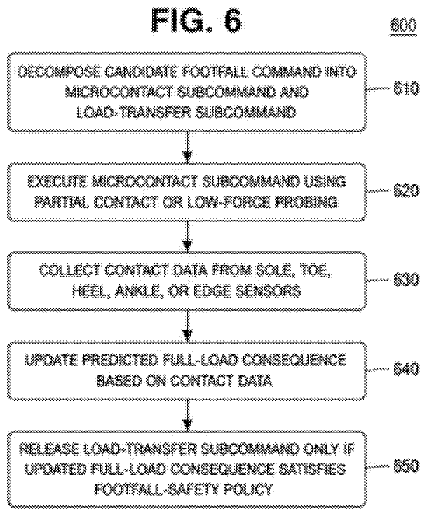

### B. Pre-Weight-Transfer Microcontact Validation Method (FIG. 6)

FIG. 6 illustrates a method 600 for pre-weight-transfer microcontact validation.

At step 610, a candidate footfall command is decomposed into a microcontact subcommand and a load-transfer subcommand. The microcontact subcommand may comprise toe probing, heel probing, perimeter probing, vibrational probing, partial-load contact, tactile sampling, or a sequence thereof. Vibrational probing may apply a bounded oscillatory input and evaluate a resulting force, displacement, acceleration, acoustic, tactile, or inertial response to estimate friction, compliance, contamination, roughness, edge proximity, or support continuity. Different portions of the robotic foot assembly may be probed independently before authorization of a later load-transfer stage.

At step 620, the robotic foot assembly executes the microcontact subcommand using partial contact or low-force probing.

At step 630, contact data is collected from sole, toe, heel, ankle, or edge sensors.

At step 640, a predicted full-load consequence is updated based on the contact data.

At step 650, the load-transfer subcommand is released only if the updated predicted full-load consequence satisfies a footfall-safety policy.

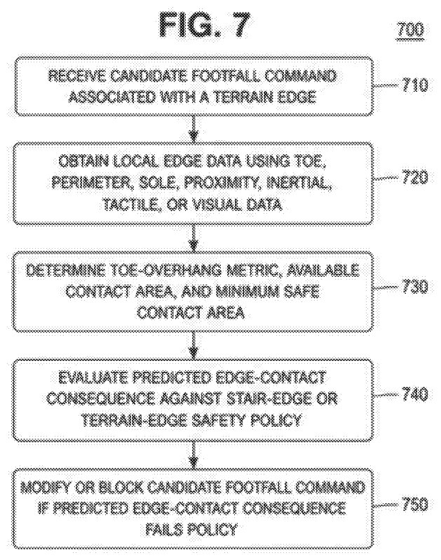

### C. Stair-Edge or Terrain-Edge Validation Method (FIG. 7)

FIG. 7 illustrates a method 700 for stair-edge or terrain-edge validation.

At step 710, a candidate footfall command associated with a terrain edge is received.

At step 720, local edge data is obtained using toe, perimeter, sole, proximity, inertial, tactile, or visual data.

At step 730, a toe-overhang metric, available contact area, and minimum safe contact area are determined.

At step 740, a predicted edge-contact consequence is evaluated against a stair-edge or terrain-edge safety policy.

At step 750, the candidate footfall command is modified or blocked if the predicted edge-contact consequence fails the policy.

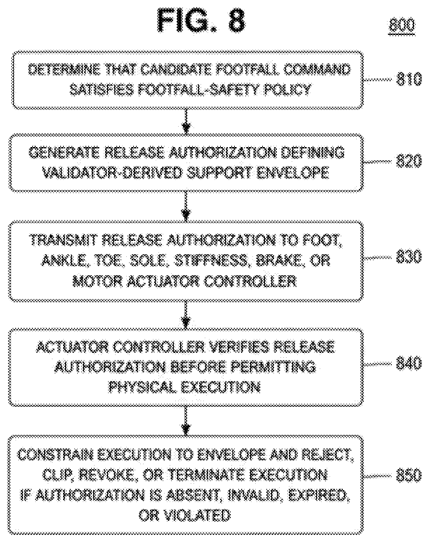

### D. Footfall Release Authorization Method (FIG. 8)

FIG. 8 illustrates a method 800 for generating and enforcing a footfall release authorization.

At step 810, a footfall-release controller determines that a candidate footfall command satisfies a footfall-safety policy.

At step 820, the footfall-release controller generates a release authorization defining a validator-derived support envelope.

At step 830, the release authorization is transmitted to a foot, ankle, toe, sole, stiffness, brake, or motor actuator controller.

At step 840, the actuator controller verifies the release authorization before permitting physical execution.

At step 850, the actuator controller constrains execution to the validator-derived support envelope and rejects, clips, revokes, or terminates execution responsive to an absent, invalid, expired, or violated authorization.

### III. Generalities

The techniques described herein may be implemented in hardware, firmware, software, or any combination thereof. A foot-local validator may be implemented as an embedded processor, microcontroller, ASIC, FPGA, neural processing unit, secure enclave, firmware routine, software module, or distributed hardware and software subsystem.

Although many examples refer to humanoid robotic feet, the same techniques may be applied to bipedal robot feet, quadruped feet, robotic hooves, robotic pads, mobile robot stabilizers, robotic legs, exoskeleton feet, prosthetic feet, warehouse robot stabilizers, construction robots, agricultural robots, medical robots, domestic robots, and other locomotion end effectors.

A “candidate footfall command” may include a command to step, place a foot, shift weight, transfer load, plant a toe, plant a heel, push off, climb a stair, descend a stair, traverse a ramp, sidestep, recover from a push, turn, brace, stabilize, balance, or otherwise physically interact with a support surface.

A “foot-local” component need not be located exclusively within a sole. It may be located in a sole, ankle, foot chassis, toe module, heel module, lower-leg housing, actuator module, foot controller, actuator controller, or mechanically and electrically associated module configured to validate foot actuation or load transfer before full execution.

A “contact consequence” may include any predicted contact-related outcome of a proposed footfall, including mechanical, electrical, thermal, material, stability, balance, safety, terrain, or task-related effects. The prediction may be explicit or implicit, model-based or learned, continuous or categorical. “Body-state context” refers to contextual state information from one or more body parts or body-level state estimators used to validate a candidate footfall. Body-state context may include same-leg state, opposing-limb state, torso state, upper-body state, hand state, payload state, center-of-mass state, momentum state, balance state, support-polygon state, or other kinematic or dynamic state. Use of body-state context by the foot-local predictive contact validator does not require the validator to control or coordinate all limbs, but instead may provide additional context for determining whether a candidate footfall should be authorized.

A “host robot” may include a humanoid robot, bipedal robot, quadruped robot, mobile robot, fixed robot, industrial robot, teleoperated robot, medical robot, warehouse robot, autonomous vehicle, drone with landing feet, or other physical AI platform configured to receive or attach a robotic foot assembly.

The validation layers described herein may be complementary. A robot-level validator may determine whether a macro-level candidate locomotion action should proceed. An operating-system-level or middleware-level actuator firewall may mediate actuator-directed requests and enforce policy across heterogeneous actuator endpoints. A foot-local validator may determine whether local contact conditions permit load transfer or foot/ankle actuation. An actuator-level enforcement layer may physically prevent unauthorized actuation. The existence of one layer does not require or exclude the existence of another layer.

The foot-local predictive contact validator may operate in coordination with, but remains distinct from, a separate multi-limb coordinated validation system. The separate multi-limb coordinated validation system may evaluate relationships among multiple limbs or body regions, whereas the foot-local predictive contact validator described herein determines whether a candidate footfall or foot-related load-transfer action should be released.

As used herein, “before full weight transfer” includes any time before a candidate foot becomes a primary or full-load support foot, including a pre-contact stage, approach stage, microcontact stage, partial-contact stage, or partial-load stage. “Before full weight transfer” does not require an absence of physical contact or zero load through the robotic foot assembly.

A release authorization may be full, partial, staged, conditional, time-bounded, actuator-specific, gait-phase-specific, or revocable. A release authorization permitting approach or microcontact does not necessarily authorize partial or full load transfer, push-off, or unrestricted actuator operation.

Components illustrated as separate functional blocks may be implemented by a common processor, controller, circuit, firmware image, software process, or hardware module, and a component illustrated as a single block may be distributed among multiple processors, controllers, circuits, firmware components, or software processes. The illustrated separation of the foot-local predictive contact validator 110, footfall-release controller interface 360, footfall-release controller 150, and actuator controllers does not require physical separation.

Although numerous embodiments describe a foot-local predictive contact validator associated with a humanoid robot, the validator may operate as a hierarchical validator beneath a robot-level runtime enforcement engine, operating-system-level actuator firewall, middleware validator, subsystem validator, joint validator, or actuator-level validator. One or more validators may cooperate while remaining independently responsible for different physical abstraction layers.

I claim:

1. A humanoid robot system comprising:
one or more processors;
a locomotion controller configured to generate a candidate footfall command for a robotic foot assembly of a humanoid robot;
a foot-local predictive contact validator configured to receive local foot state, terrain state, and body-state context and to predict, before full weight transfer through the robotic foot assembly, a contact consequence of executing the candidate footfall command; and
a footfall-release controller configured to evaluate the predicted contact consequence against a footfall-safety policy and selectively release, modify, delay, decompose, or block the candidate footfall command based on the evaluation.

2. The humanoid robot system of claim 1, wherein the candidate footfall command comprises at least one of a foot placement, ankle pose, toe angle, heel strike, gait phase, step timing, load-transfer profile, push-off command, sole stiffness command, or contact-patch target.

3. The humanoid robot system of claim 1, wherein the predicted contact consequence comprises at least one of slip risk, terrain-compliance mismatch, sole deformation, toe overhang, stair-edge instability, insufficient contact area, ankle torque overload, excessive shear force, contamination-related traction loss, support-polygon insufficiency, balance-margin loss, or unsafe load-transfer rate.

4. The humanoid robot system of claim 1, wherein the local foot state comprises at least one of sole pressure data, shear data, ankle torque data, inertial data, toe position data, sole compression data, sole wear data, contamination data, friction history, gait phase data, or terrain-edge data.

5. The humanoid robot system of claim 1, wherein the body-state context comprises same-leg state including one or more of pelvis state, hip state, upper-leg state, knee state, lower-leg state, ankle state, foot state, or toe state.

6. The humanoid robot system of claim 1, wherein the body-state context comprises opposing lower-limb state including one or more of opposite-foot contact state, opposite-foot support state, opposite-ankle torque, opposite-knee angle, opposite-hip load, or opposite-leg swing state.

7. The humanoid robot system of claim 1, wherein the body-state context comprises upper-body or payload state including one or more of torso orientation, shoulder pose, arm configuration, elbow state, wrist state, hand state, carried-payload state, object-retention state, center-of-mass state, angular momentum, balance-margin state, or support-polygon state.

8. The humanoid robot system of claim 1, wherein the foot-local predictive contact validator uses the body-state context as contextual information for determining whether to authorize the candidate footfall while the foot-local predictive contact validator remains configured to validate release of the candidate footfall.

9. The humanoid robot system of claim 1, wherein the footfall-release controller generates a release authorization defining a validator-derived support envelope for one or more foot, ankle, toe, sole, stiffness, brake, clutch, or motor actuators.

10. The humanoid robot system of claim 9, wherein the validator-derived support envelope defines at least one of a permitted foot pose, ankle torque range, toe angle range, ground reaction force range, contact area, load-transfer rate, stiffness value, damping value, gait phase, time window, terrain class, or support-polygon constraint.

11. The humanoid robot system of claim 9, wherein an actuator controller rejects a foot, ankle, toe, sole, stiffness, brake, clutch, or motor actuator command that lacks a valid release authorization or exceeds the validator-derived support envelope.

12. The humanoid robot system of claim 1, wherein the foot-local predictive contact validator performs a pre-weight-transfer microcontact validation phase before authorizing full load transfer.

13. The humanoid robot system of claim 12, wherein the pre-weight-transfer microcontact validation phase comprises low-force probing, toe probing, heel probing, perimeter probing, vibrational probing, partial load contact, or tactile sampling.

14. The humanoid robot system of claim 12, wherein the foot-local predictive contact validator updates the predicted contact consequence based on microcontact data before full weight transfer.

15. The humanoid robot system of claim 1, wherein the robotic foot assembly comprises an adaptive sole having a plurality of variable-compliance zones.

16. The humanoid robot system of claim 15, wherein the adaptive sole changes stiffness, damping, toe compliance, heel compliance, arch support, tread engagement, contact area, or frictional engagement based on a validated terrain envelope.

17. The humanoid robot system of claim 1, wherein the foot-local predictive contact validator validates a stair-edge, curb-edge, ledge-edge, threshold-edge, pallet-edge, ramp-break, or terrain-edge footfall.

18. A method comprising:
receiving a candidate footfall command for a robotic foot assembly of a humanoid robot;
obtaining local foot state, terrain state, and body-state context;
predicting, before full weight transfer through the robotic foot assembly, a contact consequence of executing the candidate footfall command;
evaluating the predicted contact consequence against a footfall-safety policy; and
selectively releasing, modifying, delaying, decomposing, or blocking the candidate footfall command based on the evaluation.

19. The method of claim 18, further comprising decomposing the candidate footfall command into an approach subcommand, a microcontact subcommand, a partial load-transfer subcommand, and a full load-transfer subcommand, wherein a later subcommand is withheld until contact data from an earlier subcommand satisfies the footfall-safety policy.

20. A non-transitory computer-readable medium storing instructions that, when executed by one or more processors, cause the one or more processors to:
receive a candidate footfall command for a humanoid robot; obtain local foot-contact data, terrain-state data, and body-state context;
predict a contact consequence of executing the candidate footfall command before full weight transfer;
determine whether the predicted contact consequence satisfies a footfall-safety policy; and
generate a release authorization for the candidate footfall command only when the predicted contact consequence satisfies the footfall-safety policy.
